(19) United States
(12) Patent Application Publication
(10) Pub. No.: US 2013/0089199 A1
(43) Pub. Date: Apr. 11, 2013

(54) Communication System in a Package Formed on a Metal Microstructure

(71) Applicants: Gilbert A. Amine, Austin, TX (US); John Kelly, Austin, TX (US); Jason L. Rabb, Austin, TX (US); David N. Wakely, Austin, TX (US)

(72) Inventors: Gilbert A. Amine, Austin, TX (US); John Kelly, Austin, TX (US); Jason L. Rabb, Austin, TX (US); David N. Wakely, Austin, TX (US)

(73) Assignee: ZARLINK SEMICONDUCTOR (U.S.) INC., Austin, TX (US)

(21) Appl. No.: 13/270,829

(22) Filed: Oct. 11, 2011

(51) Int. Cl. H04M 9/00; H04M 1/00

(52) U.S. Cl. 379/413; 379/447

(57) ABSTRACT

An apparatus includes a metal frame, a switching power circuit, and at least one semiconductor die implementing a communication interface. The metal frame includes a plurality of external pads, and a plurality of base pads coupled to selected external pads. The switching power circuit is mounted to selected base pads and includes an input terminal, an output terminal, an energy storage device mounted to a first subset of the base pads and coupled to the output terminal, and a switching element mounted to a second subset of the base pads and coupled to the input terminal and the energy storage element. The at least one semiconductor die provides a control signal to the switching device to control an output voltage present at the output terminal.

### CROSS-REFERENCE TO RELATED APPLICATIONS

Not applicable.

### BACKGROUND

The disclosed subject matter relates generally to communication systems and, more particularly, to a communication system-in-package (SIP) formed on a metal microstructure.

Voice communication systems, such as central offices, private branch exchanges (PBXs), residential gateways, and Voice over IP (VOIP) adapters generally incorporate electronic circuits to form what is commonly known as a foreign exchange subscriber (FXS). FXS circuits provide BORSCHT functions, standing for Battery feed, Over-voltage support, integrated Ringing, line Supervision, Codec, Hybrid (2W/4W), and Testing.

In the 1970's and 1980's, FXS circuits included discrete components, large transformers and/or coils, and some simple integrated circuits that made up fairly large line cards. With advances in technology, integrated circuits (ICs) were developed to provide much of these functions. These ICs typically include a high-voltage Subscriber Line Integrated Circuit (SLIC) and a mixed signal Subscriber Line Audio Controller (SLAC).

Some communication companies have combined the high-voltage (SLIC) and mixed-signal (SLAC) dies into a single multi-chip module (MCM) device. One example device is the Zarlink Le88111. Subscriber line circuits require a high-voltage negative supply to provide battery feed and ringing signals to telephones. These subscriber line power (SLP) circuits are bulky and normally include a driver circuit, a power transistor, a power inductor or transformer, one or more rectifiers, a compensation network, input (CIN) and output (GOUT) capacitors and an optional current limit resistor (RLIM). A programmable SLP circuit typically employs an inverting buck-boost, inverting-boost, or flyback technique to convert a positive input voltage, commonly 5-15V, to a negative voltage (VBAT), commonly −24 to −100V.

The subscriber line power supply is controlled by a DC-DC controller which can be a part of the SLAC functionality. The DC-DC controller may include an error amplifier and a transistor driver. The DC-DC controller provides dynamic control to the switcher circuit so that the output voltage (VBAT) corresponds to the state of the telephone line. For example, if the telephone is idle (on-hook), VBAT is normally set to −48VDC. If the telephone set goes off-hook, VBAT is set to a voltage that provides a programmable current to the line, such as 25 mA, irrespective of the length of the telephone loop. If the telephone needs to be rung (for an incoming call), VBAT may go up to −100V in order to provide the SLIC ringing amplifier enough headroom for a 60 Vrms sinusoidal ringing signal. The DC-DC controller adjusts the switching frequency and duty cycle limit using pulse width modulation (PWM) to obtain the desired VBAT voltage and/or supply current for the given state of the telephone line. Sophisticated algorithms are employed to ensure efficiency and to detect and respond to fault conditions. The subscriber line power (SLP) circuit is commonly implemented using discrete components, many of which are large and bulky. Such circuits typically take up 10-20 cm² on a printed circuit board.

The same issues are also present in other telecommunications applications, such as Power over Ethernet (PoE) Powered Devices (PD), whereby available ICs do not provide complete system solutions and modules are large and expensive. A PoE PD interface controller, which may be integrated on the same device as the DC-DC controller includes circuitry and logic for inrush current limit, and signature and classification according to industry standards.

Given that subscriber line circuits are used in very large numbers (tens of millions per year), there has been a commercial need to reduce the size of these circuits and provide modules that integrate as much functionality as possible (SLIC, SLAC, SLP). This need also extends to integrating some or all of the external components that are required by the SLIC and SLAC that are not a part of the switcher circuit (such as filter capacitors, protection, EMC capacitors, and others). The resulting devices are packaged modules that can be integrated into the end product (such as VoIP boxes or CO line cards) with minimal design effort.

Conventional modules use a PCB or ceramic substrate to connect the components that form the subscriber circuit. Such modules are generally expensive due to the added cost of the PCB or substrate material, but serve a commercial need of providing a more complete “drop-in” solution than what is possible with SLIC and SLAC ICs by integrating the high-voltage switcher circuit.

Conventional integrated subscriber line systems are not complete, as many use external components (e.g., inductors), they are expensive due to the cost of the substrate, and they fail to offer optimum thermal dissipation. The package sizes are also fairly large when the inductor and other external components are added.

This section of this document is intended to introduce various aspects of art that may be related to various aspects of the disclosed subject matter described and/or claimed below. This section provides background information to facilitate a better understanding of the various aspects of the disclosed subject matter. It should be understood that the statements in this section of this document are to be read in this light, and not as admissions of prior art. The disclosed subject matter is directed to overcoming, or at least reducing the effects of, one or more of the problems set forth above.

### BRIEF SUMMARY

The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

One aspect of the disclosed subject matter is seen in an apparatus including a metal frame, a switching power circuit, and at least one semiconductor die implementing a communication interface. The metal frame includes a plurality of external pads, and a plurality of base pads coupled to selected external pads. The switching power circuit is mounted to selected base pads and includes an input terminal, an output terminal, an energy storage device mounted to a first subset of the base pads and coupled to the output terminal, and a switching element mounted to a second subset of the base pads and coupled to the input terminal and the energy storage element. The at least one semiconductor die provides a control signal to the switching device to control an output voltage present at the output terminal.

### BRIEF DESCRIPTION OF THE SEVERAL VIEWS OF THE DRAWINGS

The disclosed subject matter will hereafter be described with reference to the accompanying drawings, wherein like reference numerals denote like elements, and:

FIG. 1 is a simplified block diagram of a System-in-Package (SIP) device in accordance with one embodiment of the present subject matter;

FIG. 2 is a simplified block diagram of an embodiment of the SiP device of FIG. 1 implementing a telephony interface;

FIG. 3 is a more detailed block diagram of a subscriber line interface circuit, a subscriber line audio processing circuit, and a subscriber line power circuit in the SiP device of FIG. 2;

FIG. 4 is a circuit diagram illustrating a switching power circuit interfacing with a controller;

FIG. 5 is a diagram of an external fused resistor used with the circuit of FIG. 4;

FIGS. 6 and 7 are top and bottom views, respectively, of a lead frame package used to package the device of FIGS. 2 and 3;

FIGS. 8 and 9 are top and bottom views, respectively, of a sintered silver metal frame package used to package the device of FIGS. 2 and 3;

FIG. 10 is a simplified block diagram of an embodiment of the SiP device of FIG. 1 implementing a Power over Ethernet (PoE) interface; and

FIG. 11 is a simplified block diagram of an embodiment of the SiP device of FIG. 1 implementing a lighting interface.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the spirit and scope of the disclosed subject matter as defined by the appended claims.

### DETAILED DESCRIPTION

One or more specific embodiments of the disclosed subject matter will be described below. It is specifically intended that the disclosed subject matter not be limited to the embodiments and illustrations contained herein, but include modified forms of those embodiments including portions of the embodiments and combinations of elements of different embodiments as come within the scope of the following claims. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the disclosed subject matter unless explicitly indicated as being “critical” or “essential.”

The disclosed subject matter will now be described with reference to the attached figures. Various structures, systems and devices are schematically depicted in the drawings for purposes of explanation only and so as to not obscure the disclosed subject matter with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

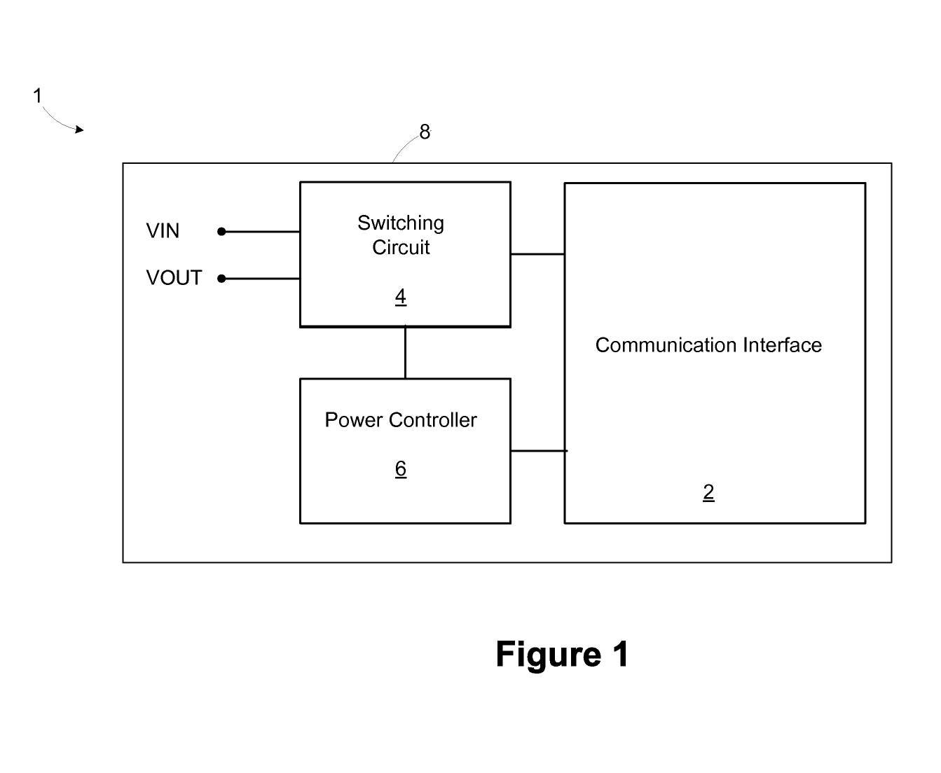

Referring now to the drawings wherein like reference numbers correspond to similar components throughout the several views and, specifically, referring to FIG. 1, the disclosed subject matter shall be described in the context of a system-in-package (SiP) communication device 1. In general, the SiP device 1 includes at least one semiconductor die 2 (i.e., more than one die may be present) implementing a communication interface, a switching power circuit 4 operable to receive an input voltage, VIN, and generate an output voltage, VOUT, based thereon, and a power controller 6 operable to control the switching power circuit 4. The communication interface die 2 directs the power controller 6 to control the operation of the switching power circuit 4. Although the communication interface die 2 and the power controller 6 are illustrated as being separate devices, it is contemplated that the power controller 6 may be integrated into the die 2. In addition, the communication interface die 2 may be a single die or may include multiple cooperating die. The die 2, switching power circuit 4, and power controller 6, are mounted to a metal frame 8.

The switching power circuit 4 generally includes a switching element, such as a transistor, and an energy storage device, such as a capacitor, as described below in greater detail. The power controller 6 implements a switching technique, such as pulse width modulation, to control the frequency and duty cycle of the switching transistor to affect the storage of energy in the energy storage device (e.g., capacitive and/or inductive elements) to generate the output voltage, Vout. The communication interface die 2 directs the operation of the power controller 6 to control the output voltage. The input voltage may be received from an external source or it may be generated within the device 1, such as by the communication interface die 2. The output voltage may be used internally within the SiP device 1, such as by the communication interface die 2. Alternatively or additionally, the output voltage may be available on an external output of the SiP device 1 for powering an external device or load. Exemplary applications for the SiP device 1 include a telephony line interface, a power over Ethernet (POE) device, or a lighting controller.

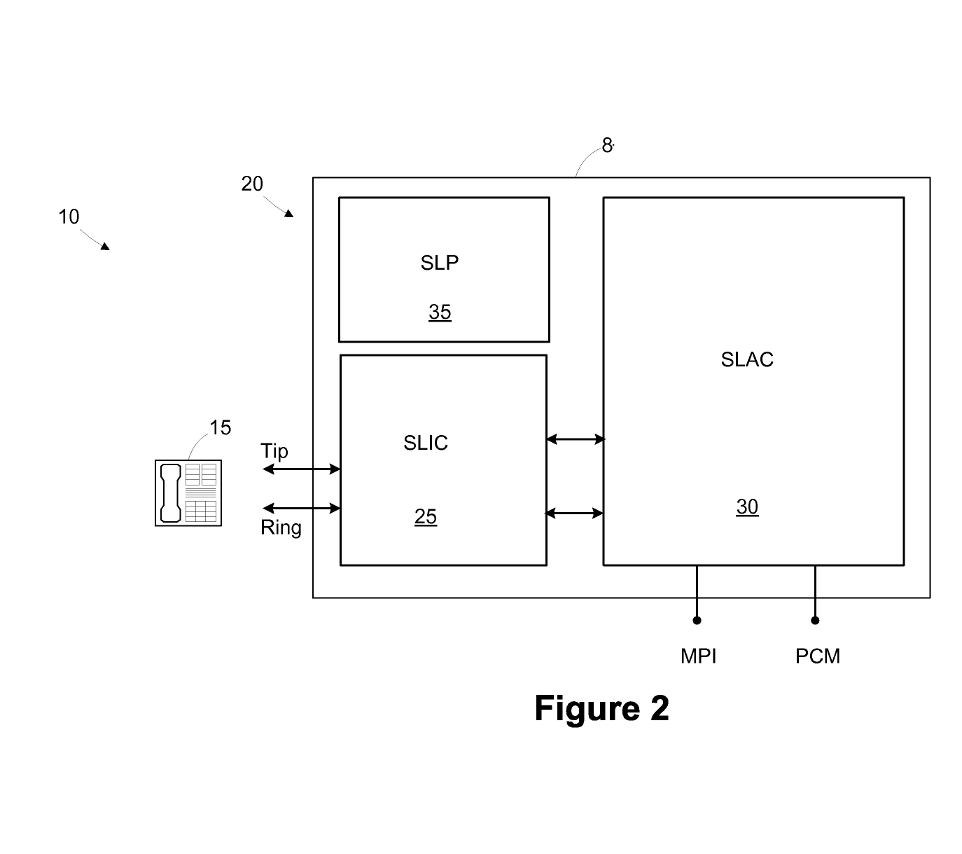

In a first illustrative embodiment shown in FIG. 2, the SiP device 1 is depicted as it may be used in a communication system 10 including a telephony device 15. The SiP device 1 is an interface device 20 for communicating within the communication system 10. The interface device 20 includes a subscriber line interface circuit (SLIC) 25, a subscriber line audio controller (SLAC) 30, and a subscriber line power (SLP) circuit 35. The interface device 20 includes a metal frame 45 to which the components of the SLIC 25, SLAC 30, and SLP 35 are mounted without the need for a printed circuit board or ceramic substrate.

A simplified functional block diagram of the SLIC 25, SLAC 30, and SLP 35 is illustrated in FIG. 2. The general operation and configuration of SLIC devices is known to those of ordinary skill in the art, so only a high level description is provided. The SLIC 25 provides the electrical interfaces for a foreign exchange subscriber (FXS) circuit for communication with the telephony device 15 over TIP and RING lines. The SLIC 25 includes an EMC filter 50 that interfaces with a TIP/RING line driver and ringing amplifier unit 55. A level shifting buffer 60 communicates with the unit 55 and a line driver interface 65, as controlled by a control unit 70.

The general operation and configuration of SLAC devices is also known to those of ordinary skill in the art, so only a high level description is provided. The SLAC 30 provides higher-level functions, such as audio signal conversion and processing, worldwide impedance matching, and call control signal generation and detection. The SLAC 30 includes a DC-DC controller 75 (e.g., the power controller 6 of FIG. 1), a supervision unit 80, a signaling unit 85, an audio processing unit 90, a digital power, analog reference, and conditioning unit 95, a microprocessor interface 100, a PLL and clock control unit 105, a PCM interface and time slot assignor 110, and an input/output unit 115. The DC-DC controller 75 performs pulse width modulation (PWM) control, compensation, and current limiting functions. The supervision unit 80 implements loop detect, ring trip, fault detect, and line diagnostics functions. The signaling unit 85 implements DC feed, ringing control, caller ID, and call progress tone generation functions. The audio processing unit 90 provides CODEC, equalization, gain control, input impedance, and hybrid balance functions.

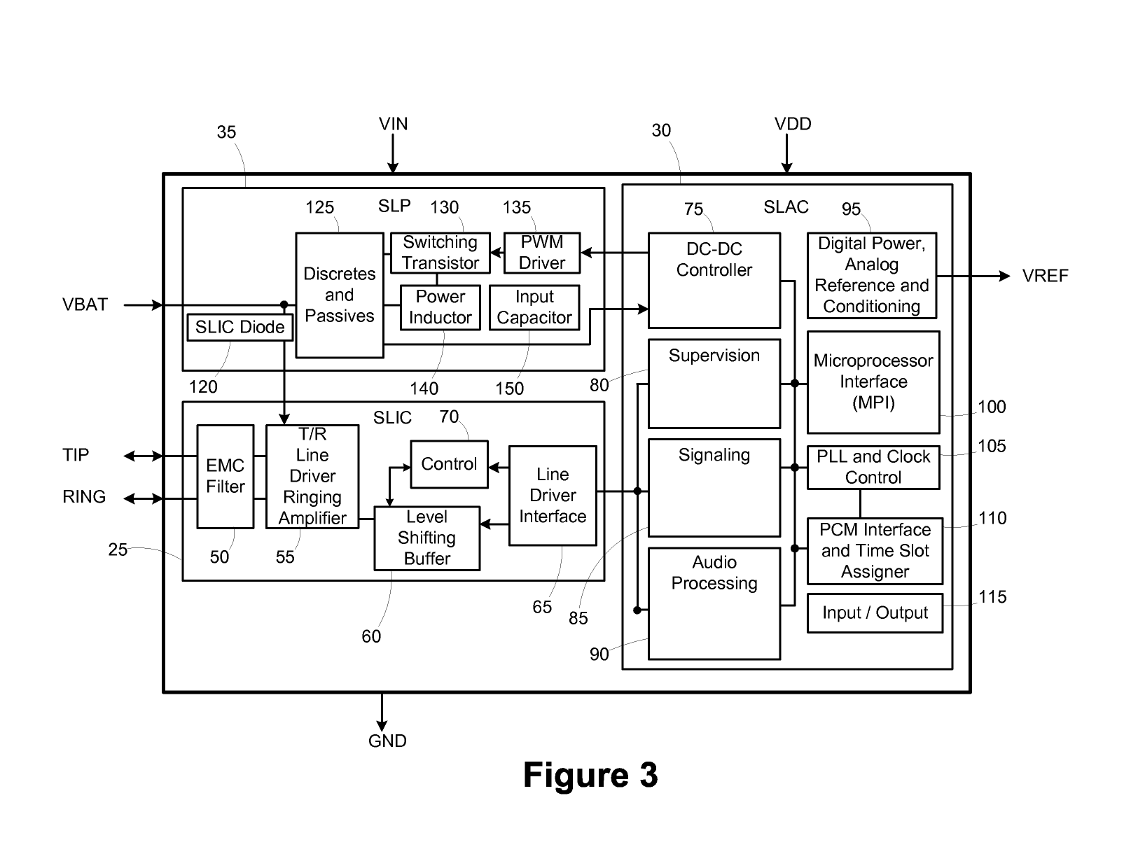

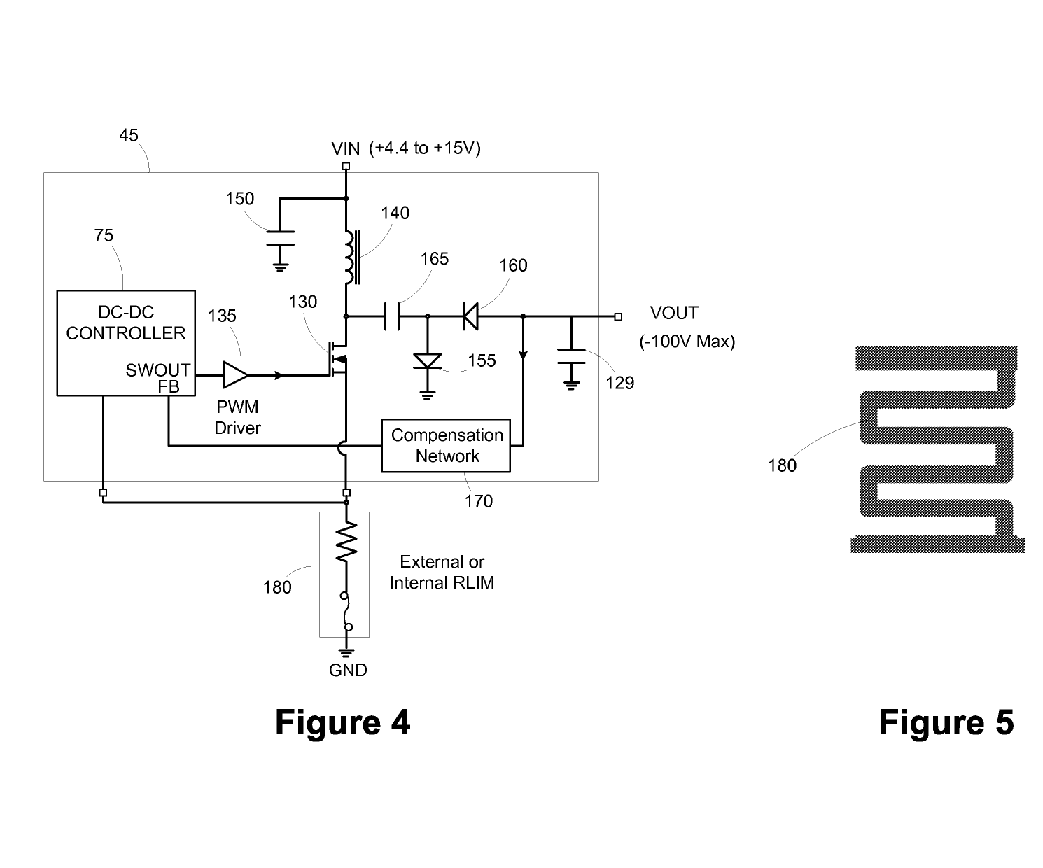

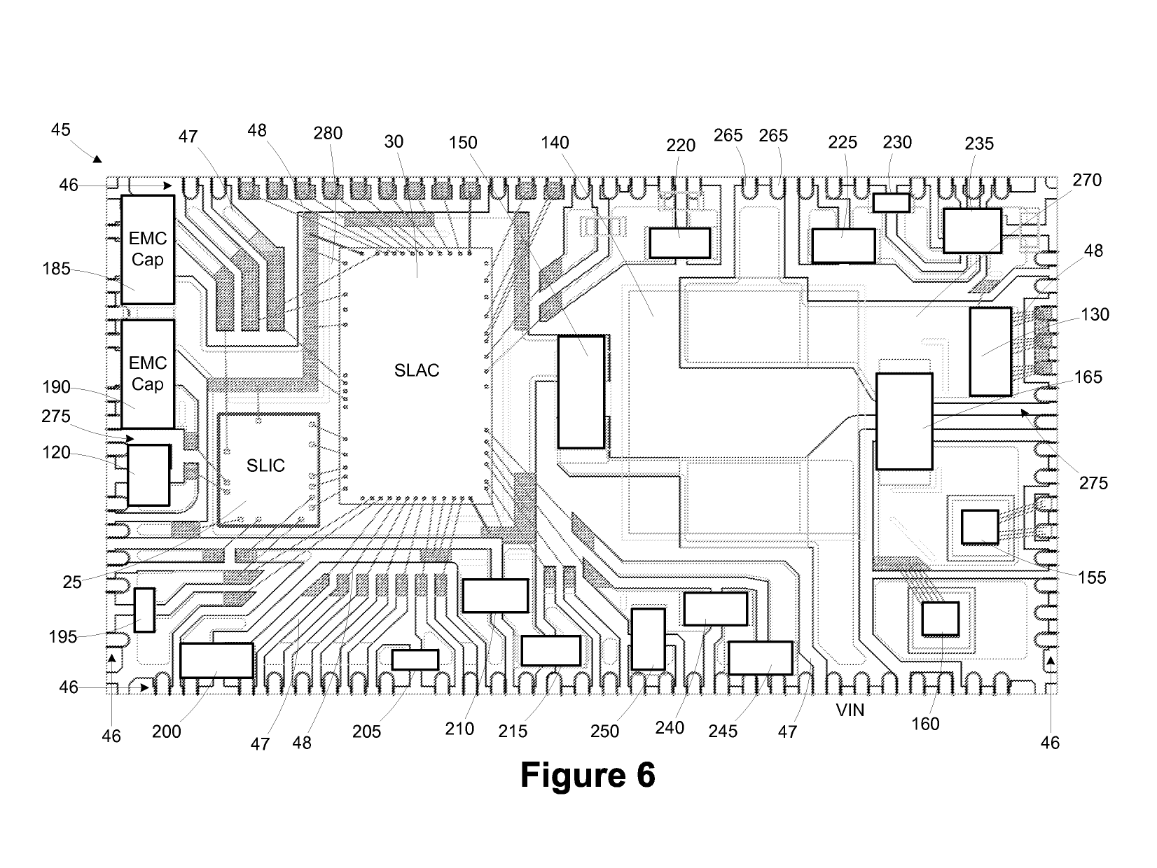

In general, the SLP 35 implements the switching power circuit 4 of FIG. 1 and employs an inverting buck, inverting-boost, or flyback technique to convert a positive input voltage (Vin) (e.g., 4.4V-15V) to a negative voltage (VBAT) (e.g., −15V to −100V). Circuit implantations for the various switching topologies are known to those of ordinary skill in the art, so they are not depicted in detail herein. A circuit diagram of the SLP 35 interfacing with the DC-DC controller 75 configured in an exemplary arrangement is shown in FIG. 4. Referring to both FIGS. 3 and 4, the SLP 35 includes a SLIC diode 120, a discrete and passive element circuit 125, a switching transistor 130, a PWM driver 135, a power inductor 140, and an input capacitor 145. The input capacitor 150 receives the external input voltage, VIN, and provides an operating voltage for the components of the SLP 35. The DC-DC controller 75 generates a battery voltage used by the SLIC 25. To generate the battery voltage, the DC-DC controller 75 of the SLAC 30 controls the PWM driver 135 to control its switching frequency and duty cycle, thereby controlling the switching transistor 130. The power inductor 140 receives the output of the switching transistor 130. As shown in FIG. 4, the discrete and passive element circuit 125 includes a rectifier implemented using diodes 155 and 160, an energy transfer capacitor 165 used for the inverting boost switcher technique, a compensation network 170, and an output capacitor 175 for storing the output battery voltage, VBAT. The SLIC diode 120 is provided as a protective device for the SLIC 25. An external current limiting resistor 180 is provided as a protection device. The current limiting resistor 180 has a very low resistance and is constructed to act as a fuse in the event the current exceeds a predetermined threshold (e.g., 8 A). The DC-DC controller 75 senses the voltage across the current limiting resistor 180 to measure and limit the current flowing through the switching transistor 130. The current limiting resistor 180 may be implemented as an external resistor, an external resistor trace mounted on circuit board, or as an internal metal pad of the metal frame 45 using base pads 47 and bond wires 48 or only bond wires 48. The fusing function of the current limiting resistor 180 may be determined based on the maximum current capacity of the bond wires 48. FIG. 5 illustrates a diagram of the current limiting resistor 180 implemented as an external resistor trace.

The switching power circuit 4 illustrated in FIG. 4 may be modified to implement inverting buck, inverting boost, inverting buck-boost, flyback, or some other switching topology by varying the location of various storage elements (e.g., inductors, capacitors), rectifiers, etc. in relation to the switching transistor. The application of the present subject matter is not limited to a particular switching topology.

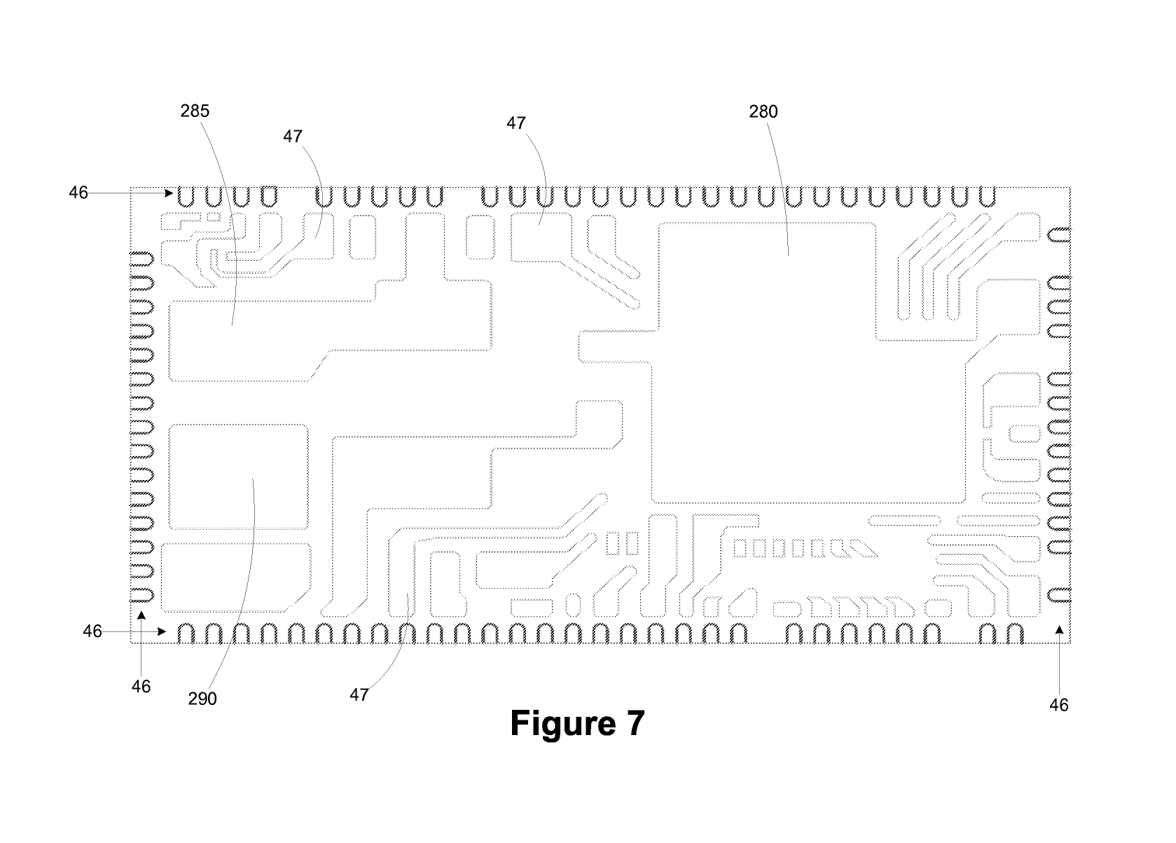

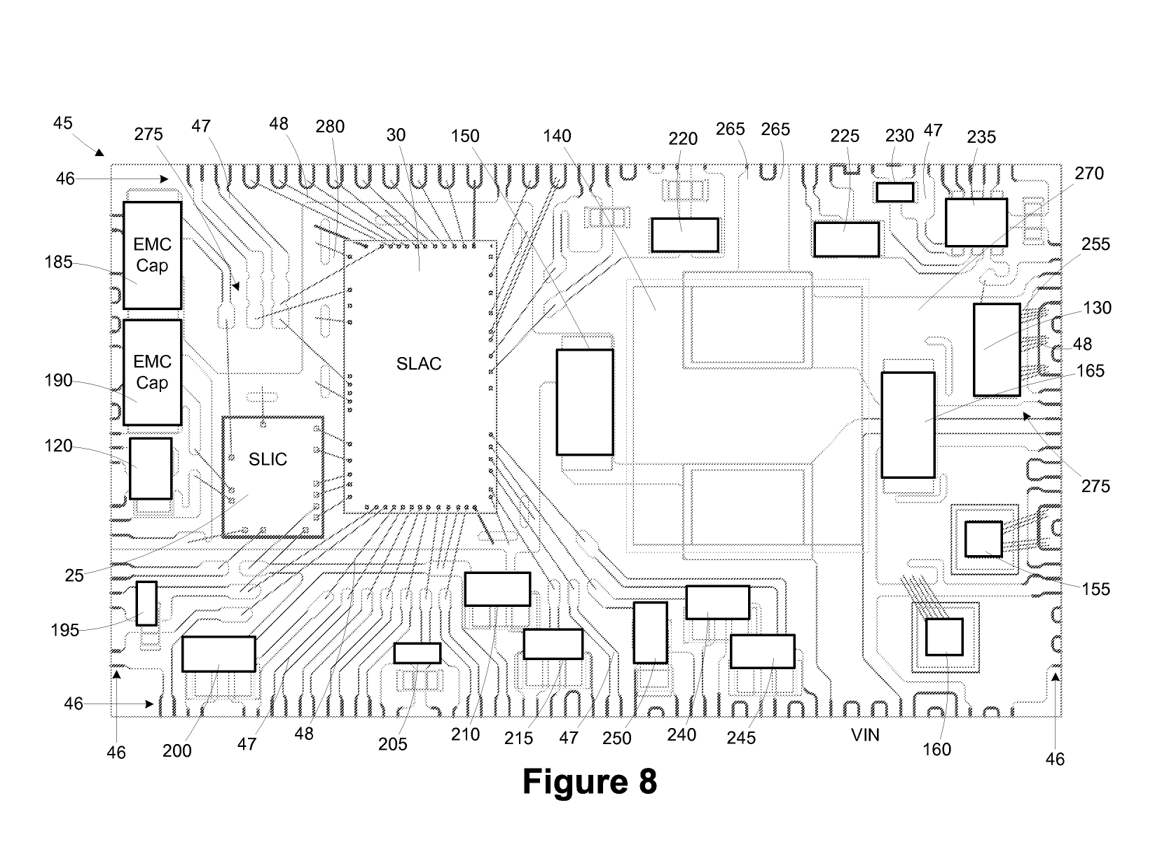

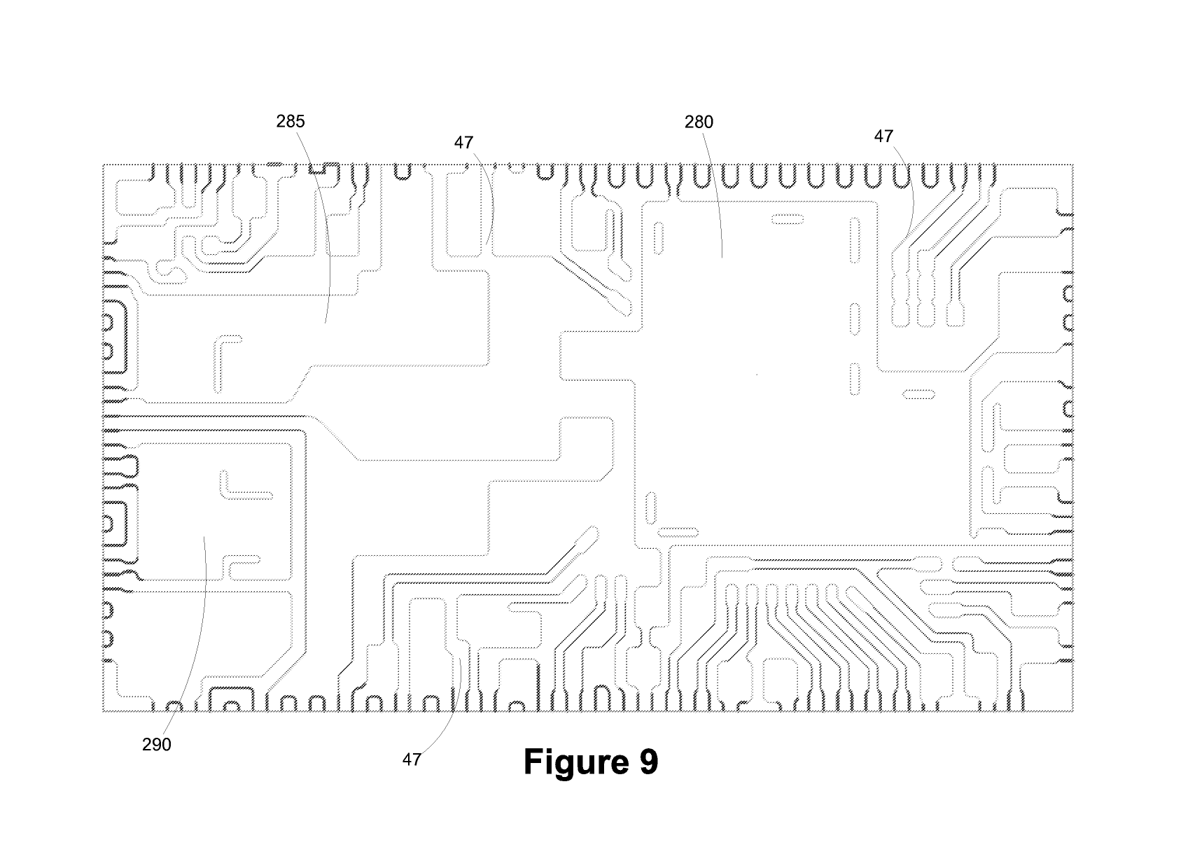

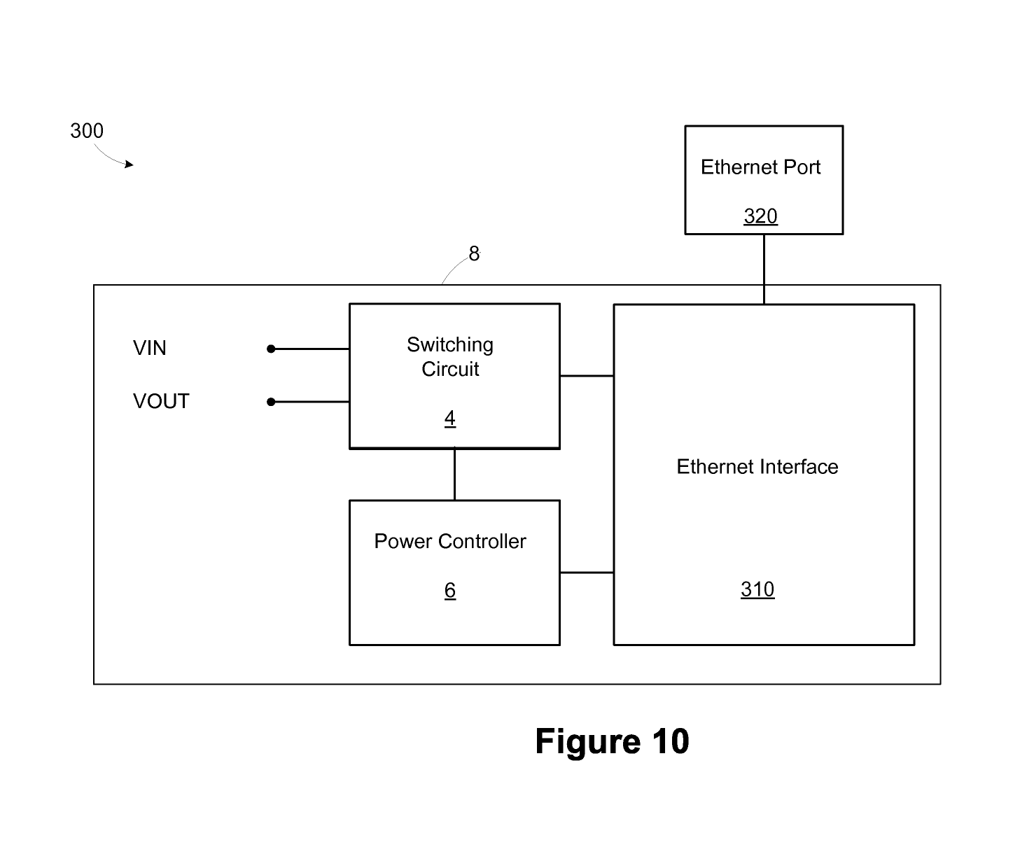

Turning now to FIGS. 6 through 9, diagrams illustrating the components of the interface device 20 mounted to the metal frame 45 are provided. FIG. 6 illustrates a top view and FIG. 7 illustrates a bottom view of a lead frame package. FIG. 8 illustrates a top view and FIG. 9 illustrates a bottom view of a sintered silver metal frame package. Generally, the metal frame 45 includes a plural of external pin pads 46, a plurality of base pads 47, and a plurality of bond wires 48. In general, the external pin pads 46 are coupled to the base pads 47, and the base pads 47 provide signal paths throughout the device. Some components are mounted directly to base pads 47, while others are connected to the base pads by bond wires 48, as shown in FIGS. 6-9. The external pin pads 48 may be coupled to pins, solder balls, etc. to provide external interfaces for the SiP device 1. In general, the components are surface mount devices. Some components may be mounted to the metal frame 45 using solder ball technology, while others may be adhesively mounted to the metal frame 45, with the bond wires 48 providing the electrical connections to the metal frame 45.

The circuitry for supporting the SLIC 25 includes the EMC filter 50 of FIG. 3, which is implemented using EMC capacitors 185, 190, and an impedance matching resistor 195 used to form the two wire AC impedance. A filtering capacitor 200, in conjunction with an internal resistor of the SLIC 25 (not shown), forms a low-pass filter for the DC feed by the SLIC 25.

Circuitry for supporting the SLAC 30 includes a resistor 205 is used to set the current reference in the SLAC 30, a reference capacitor 210 (e.g., a ceramic capacitor) connected between the internally-generated precision reference voltage, VREF, of the SLAC 30 and ground to remove high-frequency noise components, and a filtering capacitor 215 (e.g., a ceramic capacitor) used to form a low-pass filter to remove noise and voice signals from the command signal to the DC-DC controller 75.

The input capacitor 150 shown in FIG. 4 Is mounted in close proximity to the power inductor 140. The PWM driver circuit 135 of FIG. 4 is implemented by a dual transistor 220, resistors 225, and capacitors 230, 235 to receive the programmable PWM control signal from the DC-DC controller 75 of the SLAC 30 and generate the drive signal for the switching transistor 130. In some embodiments, the PWM driver circuit 135 may be integrated with the SLAC 30, as opposed to being external to the SLAC 30 as illustrated in FIG. 6. The compensation network 170 is implemented by two resistors 240, 245, and a capacitor 250. The compensation network 170 allows the SLAC 30 to sense VOUT and to adjust its frequency and phase for stability across its operating range. The sensed voltage is compared to an internal precise voltage in order to adjust the PWM, if necessary, for given drive and load requirement.

External pin pads 265 are provided to allow the use of an external inductor (not shown). A base pad 270 is provided for efficient heat transfer and a high current connection for the switching transistor 130. High voltage isolation gaps 275 are provided for separating high and low voltage components. As seen in FIGS. 7 and 8, a metal base ground pad 280, a high voltage transistor base pad 285, and a high voltage rectifier base pad 290 are provided. External nets (not shown) may be connected to the SiP device 1 to filter incoming or outgoing signals, such as but not limited to Vin and Vout, provided at the external pads 46.

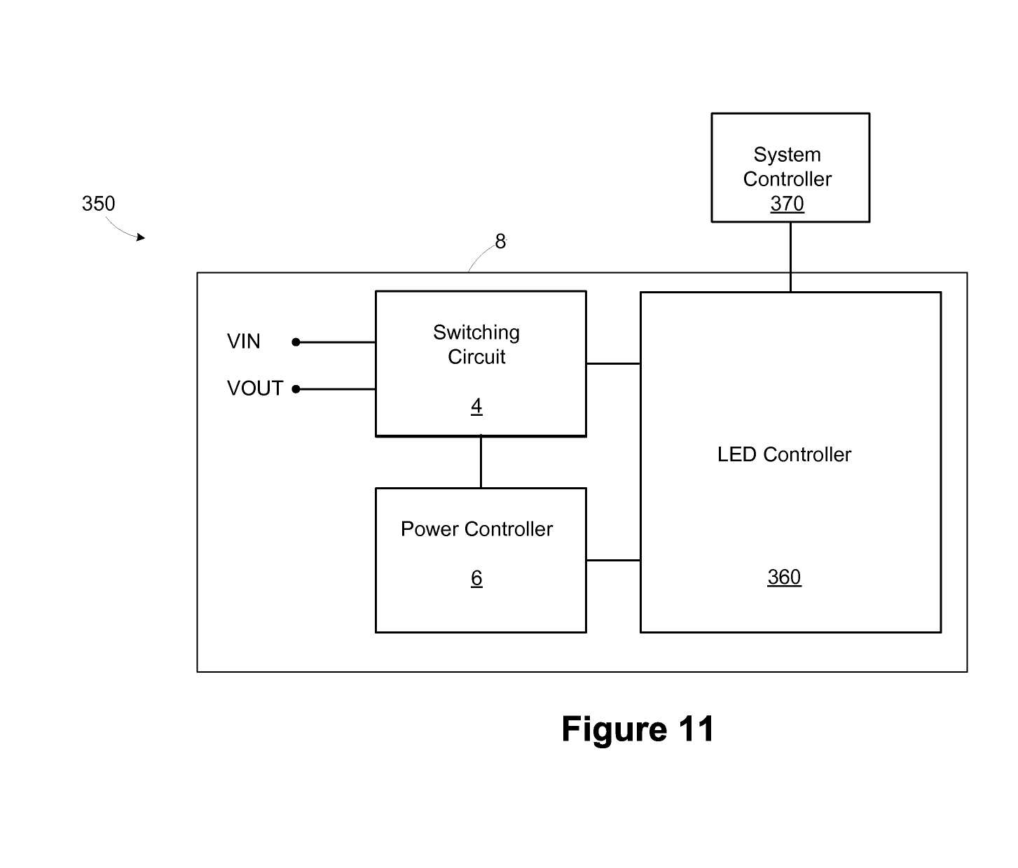

Turning now to FIG. 10, another embodiment of a SiP device 300 is illustrated. The semiconductor die 2 of FIG. 1 implements a power over Ethernet interface 310. The Ethernet interface 310 employs the output voltage generated by the switching power circuit 4 to provide power for more connected power over Ethernet (PoE) devices 320 using an Ethernet port. The SIP device 300 may represent a powered device (PD) or a power sourcing equipment (PSE) device. The PoE interface 310 may include an Ethernet physical layer transceiver (PHY). The general operation and configuration of a PoE interface is known to those of ordinary skill in the art, so a detailed description is not provided. The SiP device 300 uses a metal frame 8 similar to the metal frame 45 structure illustrated in FIGS. 6-9. Components of the switching power circuit 4 and/or the controller 6 may be similar to those illustrated in FIGS. 5-9. The particular layout of the components of the switching power circuit 4 and power controller 6 on the metal frame 8 may vary depending on the switching topology used and the requirements of the die implementing the PoE interface 310. As described above, the power controller 6 may be integrated into the PoE interface 310.

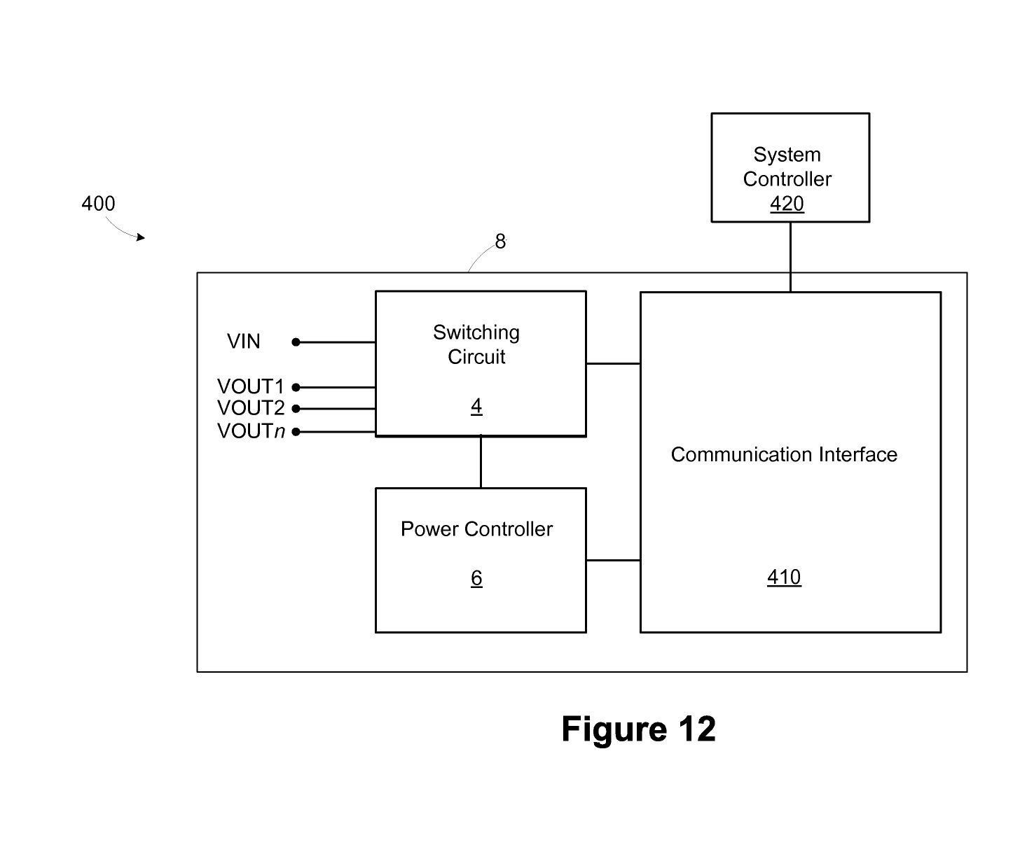

As shown in FIG. 11, another embodiment of a SiP device 350 is illustrated. The semiconductor die 2 of FIG. 1 implements an LED controller 360. The LED controller 360 implements a communication interface, such as an I2C or SPI interface, for communicating with external devices, for example, to implement a lighting network. The LED controller 360 employs the output voltage generated by the switching power circuit 4 to provide power to one or more connected lighting devices such as light emitting diode (LED) devices, via a system controller 370. The general operation and configuration of an LED controller 360 is known to those of ordinary skill in the art, so a detailed description is not provided. The SiP device 350 also uses a metal frame 8 similar to the metal frame 45 illustrated in FIGS. 6-9. Components of the switching power circuit 4 and/or the controller 6 may be similar to those illustrated in FIGS. 5-9. Again, the particular layout of the components of the switching power circuit 4 and power controller 6 on the metal frame 8 may vary depending on the switching topology used and the requirements of the die implementing the lighting controller 360. As described above, the power controller 6 may be integrated into the PoE interface 310.

As shown in FIG. 12, another embodiment of a SiP device 400 is illustrated. The semiconductor die 2 of FIG. 1 implements a communication interface 410. The communication interface 410 implements an externally programmable point of load system, and communicates using a protocol, such as I2C, SPI, UART, PMBus, SMBus, USB, VID, etc. to communicate with a system controller 420. The externally programmable point of load system operates similarly to the lighting controller of FIG. 11, but provides multiple VOUT outputs. The general operation and configuration of the communication interface 410 implementing the externally programmable point of load system is known to those of ordinary skill in the art, so a detailed description is not provided. The SiP device 400 also uses a metal frame 8 similar to the metal frame 45 illustrated in FIGS. 6-9. Components of the switching power circuit 4 and/or the controller 6 may be similar to those illustrated in FIGS. 5-9. Again, the particular layout of the components of the switching power circuit 4 and power controller 6 on the metal frame 8 may vary depending on the switching topology used and the requirements of the die implementing the communication interface 410. As described above, the power controller 6 may be integrated into the communication interface 410.

The use of the metal frame 8, 45 described herein allows the communication interface semiconductor die 2 and components used in implementing the switching power circuit 4 and power controller 6 to be packaged without the need for a substrate to support the metal interconnections. For example, the metal frame 8, 45 may be a lead frame or a sintered silver frame. The metal microstructure provides all of the necessary interconnections. The particular processes used to generate the metal frame 8, 45, mount the die 2 and other components, and complete the packaging of the SiP device 1 are known to those of ordinary skill in the art. In general, the metal frame 8 including the external pin pads 46, the base pads 47, and the bond wires 48 and the components mounted thereto are encapsulated with a resin or polymer material to complete the package. The use of the metal frame 8, 45 eliminates the need to employ a printed circuit board or a ceramic substrate to support some or all of the components and interconnections, thereby allowing a reduced package size and/or reduced cost.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the disclosed subject matter. Accordingly, the protection sought herein is as set forth in the claims below.

We claim:

1. An apparatus, comprising:
a metal frame, comprising:
a plurality of external pads;
a plurality of base pads coupled to selected external pads;
a switching power circuit mounted to selected base pads, comprising:
an input terminal;
an output terminal;
an energy storage device mounted to a first subset of the base pads and coupled to the output terminal; and
a switching element mounted to a second subset of the base pads and coupled to the input terminal and the energy storage element; and
at least one semiconductor die operable to implement a communication interface and provide a control signal to the switching device to control an output voltage present at the output terminal.

2. The apparatus of claim 1, wherein the output terminal is coupled to one of the external pads.

3. The apparatus of claim 1, wherein the output terminal is coupled to the at least one semiconductor die.

4. The apparatus of claim 1, wherein the switching power circuit comprises a power controller coupled between the semiconductor die and the switching element.

5. The apparatus of claim 4, wherein the power controller is operable to control at least one of a duty cycle or a frequency of the switching element.

6. The apparatus of claim 1, wherein the metal frame comprises one of a lead frame or a sintered silver metal frame,

7. The apparatus of claim 1, further comprising a plurality of bond wires coupling the semiconductor die to selected base pads.

8. The apparatus of claim 1, wherein the energy storage element comprises a ceramic capacitor mounted to the first subset of the base pads.

9. The apparatus of claim 1, wherein the switching element comprises a switching transistor mounted to the second subset of the base pads.

10. The apparatus of claim 1, wherein the at least one die comprises a subscriber line audio processing circuit die operable to provide the control signal to the switching device and a subscriber line interface circuit die coupled to the output terminal, and the communication interface comprises a telephony interface.

11. The apparatus of claim 1, wherein the at least one die comprises a power over Ethernet die operable to provide the control signal to the switching device and coupled to the output terminal, and the communication interface comprises a power over Ethernet interface.

12. The apparatus of claim 1, wherein the at least one die comprises a lighting controller, and the output terminal is coupled to at least one of the external pads.

13. The apparatus of claim 1, wherein the at least one die comprises a communication interface, and the switching power circuit comprises a plurality of output terminals coupled to selected external pads.

14. The apparatus of claim 1, further comprising a material encapsulating the metal frame, the switching power circuit, and the semiconductor die.

15. The apparatus of claim 14, further comprising a plurality of pins coupled to the external pads, wherein the pins are exposed by the encapsulating material.

16. The apparatus of claim 1, wherein the metal frame comprises an inductor coupled to the switching power circuit.

17. The apparatus of claim 1, wherein the switching power circuit further comprises a current limiting resistor coupled to the switching element.

18. The apparatus of claim 17, wherein the current limiting resistor comprises at least one of the base pads.

19. The apparatus of claim 17, wherein the current limiting resistor comprises a bond wire.

20. The apparatus of claim 17, wherein the current limiting resistor comprises a printed circuit board and a metal trace formed on the printed circuit board, wherein the current limiting resistor is coupled to one of the external pads and is external to the metal frame.

21. A telephony interface device, comprising:
a metal frame, comprising:
a plurality of external pads;
a plurality of base pads coupled to selected external pads;
a subscriber line power circuit coupled to the base pads, comprising:
a switching power circuit mounted to selected base pads, comprising:
an input terminal;
an output terminal;
an energy storage device mounted to a first subset of the base pads and coupled to the output terminal; and
a switching element mounted to a second subset of the base pads and coupled to the input terminal and the energy storage element;
a subscriber line audio processing circuit die mounted to the base pads and operable to control the subscriber line power circuit to generate a battery voltage signal at an output terminal of the subscriber line power circuit; and
a subscriber line interface circuit die mounted to the base pads and coupled to the output terminal.

22. The device of claim 21, wherein the subscriber line power circuit comprises:
a switching power circuit mounted to selected base pads, comprising:
an input terminal coupled to one of the external pads;
an output terminal;
an energy storage device mounted to a first subset of the base pads and coupled to the output terminal; and
a switching element mounted to a second subset of the base pads and coupled to the input terminal and the energy storage element.

23. The device of claim 22, wherein the switching power circuit comprises a power controller coupled between the semiconductor die and the switching element.

24. The device of claim 22, wherein the power controller is operable to control at least one of a duty cycle or a frequency of the switching element.

25. The device of claim 21, wherein the metal frame comprises one of a lead frame or a sintered silver metal frame,

26. The device of claim 21, further comprising a plurality of bond wires coupling the subscriber line audio processing die and the subscriber line interface circuit die to selected base pads.

27. The device of claim 21, wherein the energy storage element comprises a ceramic capacitor mounted to the first subset of the base pads.

28. The device of claim 21, wherein the switching element comprises a switching transistor mounted to the second subset of the base pads.

29. The device of claim 22, wherein the switching power circuit further comprises a current limiting resistor coupled to the switching element.

30. The device of claim 29, wherein the current limiting resistor comprises at least one of the base pads and a bond wire.

31. The device of claim 29, wherein the current limiting resistor comprises a printed circuit board and a metal trace formed on the printed circuit board, wherein the current limiting resistor is coupled to one of the external pads and is external to the metal frame.
